(19) United States
(12) Patent Application Publication
(10) Pub. No.: US 2022/0408709 A1
(43) Pub. Date: Dec. 29, 2022

(54) Rod Holder for Boat Top

(71) Applicant: Cory Kato, Flagler Beach, FL (US)

(72) Inventor: Cory Kato, Flagler Beach, FL (US)

(21) Appl. No.: 17/741,031

(22) Filed: May 10, 2022

Related U.S. Application Data
(60) Provisional application No. 63/186,345, filed on May 10, 2021.

(51) Int. Cl. A01K 97/10

(52) U.S. Cl. CPC A01K 97/10

(57) ABSTRACT

A holder for securing a rod, having a rod end and an oppositely disposed rod tip, to a boat top having at least a first pole and a spaced-apart second pole, includes a rod end assembly that includes a first clamp that is securable to the first pole and a rod end extension that is configured to secure the rod end, the rod end. A rod tip assembly includes a second clamp that is securable to the second pole and a rod tip extension that is configured to secure the rod tip. The rod end assembly and the rod tip assembly each include an angular adjustment mechanism that adjusts an angle of each of the rod end assembly and the rod tip assembly so as to align the rod end extension with the rod tip extension.

### CROSS-REFERENCE TO RELATED APPLICATION(S)

This application claims the benefit of U.S. Provisional Patent Application Ser. No. 63/186,345, filed May 10, 2021, the entirety of which is hereby incorporated herein by reference.

### BACKGROUND OF THE INVENTION

### 1. Field of the Invention

The present invention relates to boat attachments and, more specifically, to an attachment for securing rods to boat tops.

### BRIEF DESCRIPTION OF THE FIGURES OF THE DRAWINGS

FIG. 1 is a photograph of one embodiment of a holder for securing a rod to a boat.

FIG. 2A is a perspective view of one embodiment of a rod end assembly.

FIG. 2B is a perspective view of one embodiment of an outer clamp.

FIG. 2C is a perspective view of one embodiment of an inner clamp.

FIG. 2D is a perspective view of one embodiment of a rod end.

FIG. 2E is a schematic diagram of one embodiment of a rod end assembly.

FIG. 2F is a perspective view of one embodiment of a rod tip assembly.

FIG. 2G is a perspective view of one embodiment of a rod tip.

FIG. 3 is a photograph of a second embodiment of a rod holder.

FIGS. 4A-4C is a photograph of a second embodiment of a rod holder.

FIGS. 5A-5B are schematic diagrams of the second embodiment of a rod holder.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

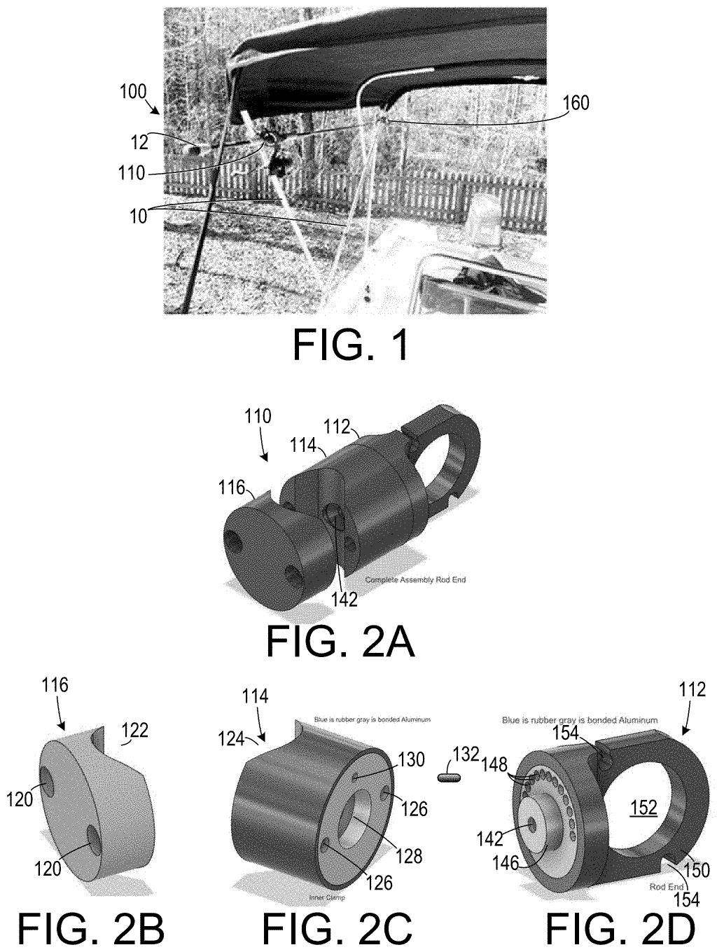

As shown in FIG. 1, one embodiment of a fishing rod 12 holder 100 for a boat top (such as a Bimini top held up by a plurality of upright poles 10) includes a rod end assembly 110 and a rod tip assembly 160. The user attaches the rod end assembly 110 to one of the upright poles 10 and the rod tip assembly 160 to another one of the poles 10. Prior to attachment, the rod end assembly 110 and the rod tip assembly 160 are set to an angle so that the fishing rod 12 is substantially level when placed in the holder 100.

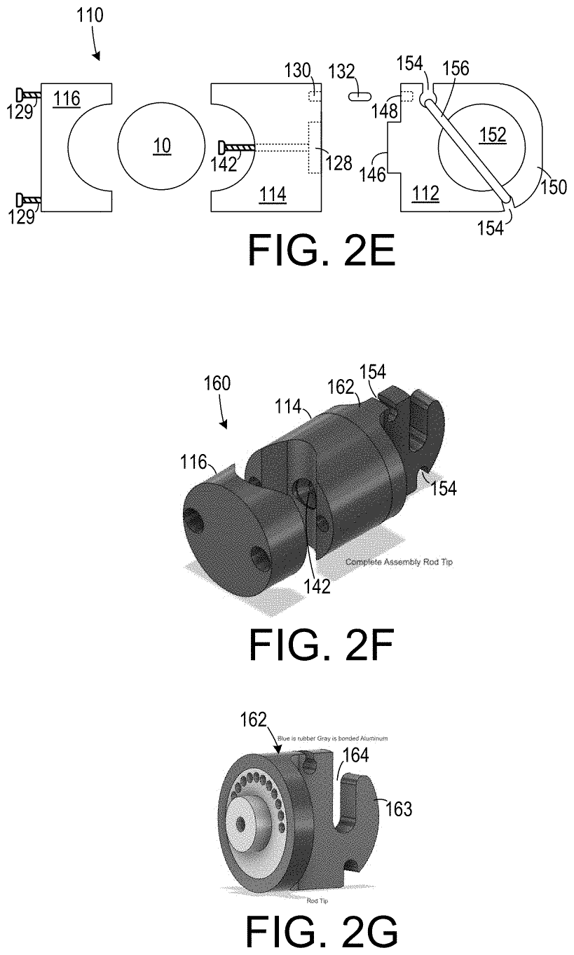

As shown in FIGS. 2A-2E, the rod end assembly 110 includes an outer clamp 116, and inner clamp 114 and a rod end 112. The inner clamp 114 defines a coupling cavity 128 and a locking pin hole 130. The rod end 112 includes a coupling protrusion 146 that is complementary in shape to the coupling cavity 128. The rod end 112 also includes a plurality of angle locking holes 148. To set the angle of the rod end 112 relative to the pole 10, the user places a locking pin 132 into the locking pin hole 130 and fits the coupling protrusion 146 into the coupling cavity 128 and the locking pin 132 into one of the angle locking holes 148 selected for the proper angle. A screw 142 then affixes the inner clamp 114 to the rod end 112. The rod end 112 includes an extension 150 that defines a hole 152 for placement of the handle side of a fishing rod therein and two notches 154 for receiving an elastic band 156 for securing the fighting to the rod end extension 150.

The outer clamp defines an indentation 122 that is complementary in shape to half of the pole 10 and the inner clamp 114 also defines an indentation 124 that is complementary in shape to half of the pole 10. After the inner clamp 114 is affixed to the rod end 112, they are set around the pole 10 and affixed to each other with screws 129 through screw holes 120 and 126.

The rod tip assembly 160 is constructed similarly to the rod end assembly 110, except that it has rod tip 162 with an extension 163 defining a narrow opening 164 for holding the far end of the fishing rod.

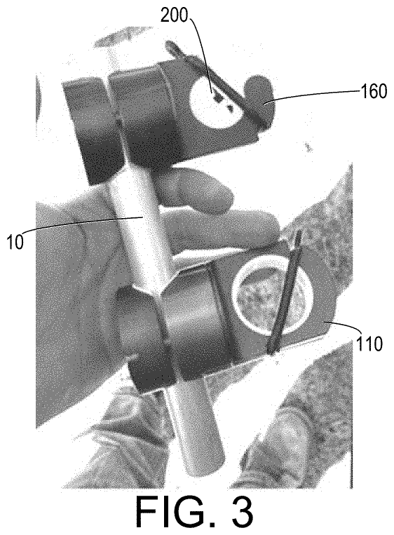

An alternate embodiment with an interchangeable rod tip holder 200 is shown in FIG. 3.

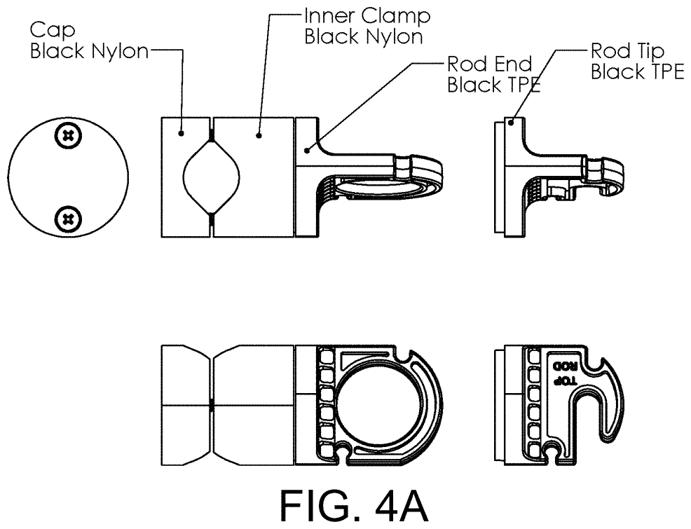

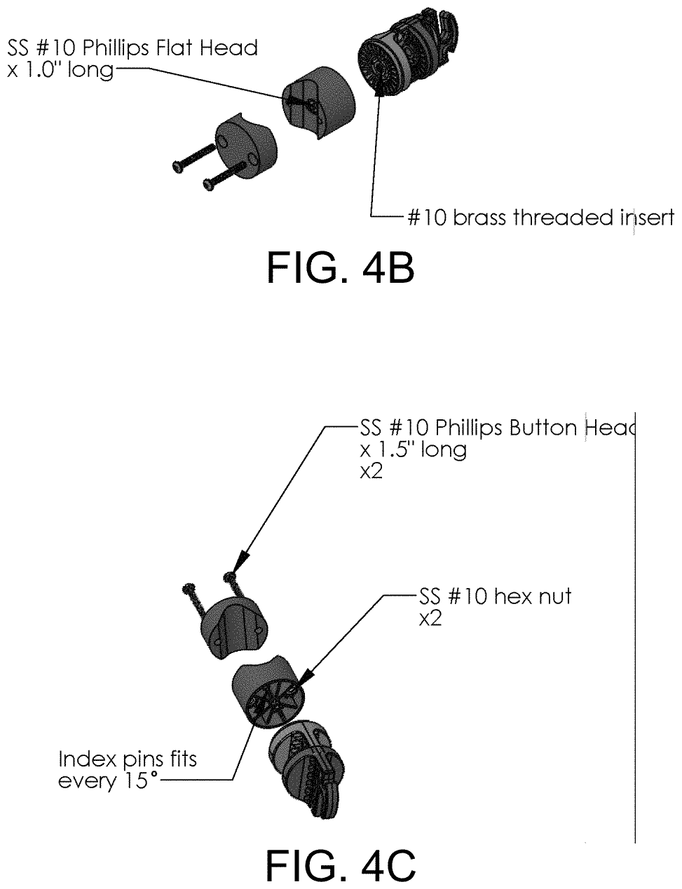

An alternate embodiment in which the indexing uses a plurality of concave slots, rather than a locking pin and locking holes, is shown in FIGS. 4A-4C.

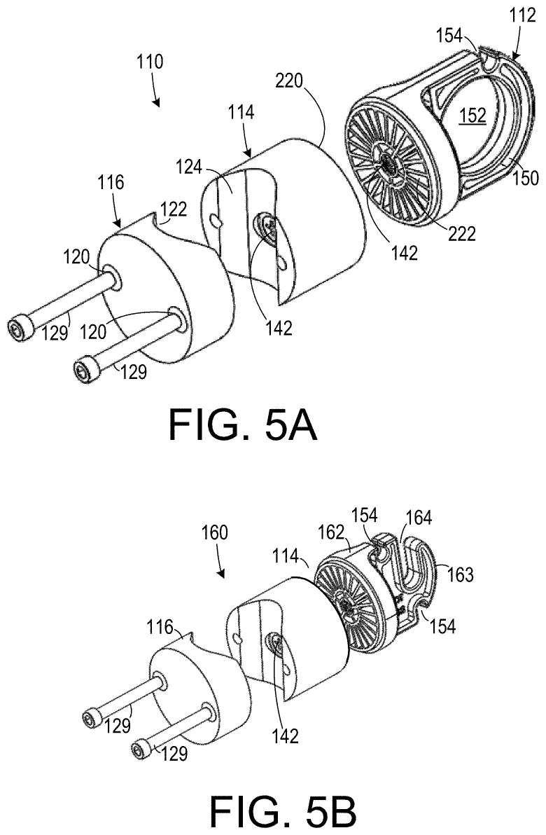

This embodiment is shown in more detail in FIGS. 5A and 5B, in which index pins 220 engage the concave slots 222. One can adjust the angle of the rod tip assembly 160 and the rod end assembly 110 by loosening the holding screws 142, rotating the rod end extension 150 and the rod tip extension 162 to the desired angle and then tightening the holding screws 142 so that the index pins 220 engage the concave slots 222, thereby holding the extensions at the desired angle.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A holder for securing a rod, having a rod end and an oppositely disposed rod tip, to a boat top having at least a first pole and a spaced-apart second pole, comprising:
(a) a rod end assembly that includes a first clamp that is securable to the first pole and a rod end extension that is configured to secure the rod end, the rod end; and
(b) a rod tip assembly that includes a second clamp that is securable to the second pole and a rod tip extension that is configured to secure the rod tip,
wherein the rod end assembly and the rod tip assembly each include an angular adjustment mechanism that adjusts an angle of each of the rod end assembly and the rod tip assembly so as to align the rod end extension with the rod tip extension.

2. The holder of claim 1, wherein the first clamp and the second claim each comprises nylon.

3. The holder of claim 1, wherein the rod end extension and the rod tip extension each comprises thermoplastic elastomer.
